(19) United States
(12) Patent Application Publication
(10) Pub. No.: US 2015/0379511 A1
(43) Pub. Date: Dec. 31, 2015

(54) CRYPTOGRAPHIC TRUST VERIFICATION SYSTEM

(71) Applicant: Double Prime Inc., Ardmore, PA (US)

(72) Inventor: James HARTLING, Ardmore, PA (US)

(21) Appl. No.: 14/733,111

(22) Filed: Jun. 8, 2015

Related U.S. Application Data
(60) Provisional application No. 62/008,572, filed on Jun. 6, 2014.

(51) Int. Cl. G06Q 20/40; G06Q 20/38

(52) U.S. Cl. CPC G06Q 20/401; G06Q 20/3825; G06Q 2220/00

(57) ABSTRACT

A verification engine for verifying that a retailer is an authorized sales channel for goods created by a manufacturer includes a controller configured to receive a verification request from a purported retailer initiated by a customer seeking to purchase goods. The request includes verification data and a first signature. The verification data includes at least identification of the purported retailer and the goods manufacturer, and the first signature includes a result of an operation on the verification data by a cryptographic key provided by the purported retailer. The verification data is compared to a listing to determine if the purported retailer is an authorized retailer. If so, a second signature is generated and compared to the first. A message is sent to the customer verifying or denying a relationship between the purported retailer and the goods manufacturer based on one or more of the comparisons.

### CROSS-REFERENCE TO RELATED APPLICATIONS

This application claims the benefit of U.S. Provisional Patent Application No. 62/008,572, filed on Jun. 6, 2014, entitled “Cryptographic Trust Verification System,” the entire contents of which are incorporated by reference herein.

### BACKGROUND OF THE INVENTION

The matter of trust has taken on a new dimension in the modern world. It is generally no longer the case that parties conducting business ever meet physically. Indeed, in a system like e-commerce, a human is involved on only one side of the transaction. Confidence in the security of one's personal data is provided by encryption services, such as the familiar “https” and lock icon prevalent in web browsers. Third party companies like Verisign, Comodo, and the like are trusted entities that affirm the identities of the host website, having validated the site's integrity and issued a Secure Sockets Layer (SSL) certificate. However, this service only ensures that data is sent in a way that does not allow interception. It does nothing to affirm the validity of the data being sent.

From a consumer perspective, there is great value in knowing that a merchant claiming to be selling a product has an active and mutual trust relationship with a manufacturer of that product. Traditional methods in a commerce context, including statements such as “authorized retailer” or the like, may be easily bypassed by a determined false player. It is therefore desirable to provide a system which can establish and guarantee the relationship between two parties for the benefit of a third. Further, it is important that the guarantor be an independent fourth party who can manage and validate the relationships being affirmed in an impartial manner. That fourth party would be the system managing the interactions between the other three, and guaranteeing that two of those entities have a formal relationship.

### BRIEF SUMMARY OF THE INVENTION

Briefly stated, an embodiment of the present invention comprises a verification engine for verifying that a retailer is an authorized sales channel for goods created by a manufacturer. The verification engine includes a memory configured to store a listing of authorized retailers for one or more manufacturers and a unique cryptographic key for each authorized retailer and manufacturer pair. A controller is configured to receive a request for verification from a purported retailer. The request is initiated by a computing device of a customer seeking to purchase goods made by one of the one or more manufacturers from the purported retailer. The request includes verification data and a first signature. The verification data includes at least an identification of the purported retailer and an identification of the goods manufacturer, and the first signature including a result of an operation on the verification data by a cryptographic key provided by the purported retailer. The controller is further configured to compare the verification data to the listing in the memory to determine if the purported retailer is an authorized retailer of the goods manufacturer, if the purported retailer is an authorized retailer of the goods manufacturer, operate on the verification data using the corresponding unique cryptographic key stored in the memory to generate a second signature, compare the first and second signatures to one another, and send a message to the customer verifying or denying a relationship between the purported retailer and the goods manufacturer based on one or more of the comparison of the verification data with the listing and the comparison of the first and second signatures.

### BRIEF DESCRIPTION OF THE SEVERAL VIEWS OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic block diagram of a system in accordance with a preferred embodiment of the present invention; and

FIG. 2 is a communication sequence diagram among a customer, a retailer website, and a verification engine in the system of FIG. 1.

### DETAILED DESCRIPTION OF THE INVENTION

Certain terminology is used in the following description for convenience only and is not limiting. The words “right,” “left,” “lower” and “upper” designate directions in the drawings to which reference is made. The words “inwardly” and “outwardly” refer to directions toward and away from, respectively, the geometric center of the device and designated parts thereof. Unless specifically set forth herein, the terms “a”, “an” and “the” are not limited to one element but instead should be read as meaning “at least one”. The terminology includes the words noted above, derivatives thereof and words of similar import.

Embodiments of the present invention are directed to “cryptographic trust verification process,” which provides any number of entities with an independent verification of their relationships with each other. The modern digital world presents substantial risk that any information or promise of integrity is trustworthy, and the system described herein aims to address that shortfall. For purposes of illustrating the service and the technology, an example embodiment in the field of online retail is described below with reference to the drawings. However, one of ordinary skill in the art recognizes that this technology extends naturally to any situation in which mutual trust must be established amongst different groups.

In the following example, retailers, manufacturers, and customers would employ a system in accordance with the present invention to achieve a mutual assurance of integrity around the purchase of a product. The shift in manufacturing centers, and the rapid advance of the consumer economy in many parts of the world, has created a gray area in which many luxury brands are vulnerable to various means of harm. These vectors range from gray market sales, which at best circumvent local tax laws while leaving the product unadulterated, to outright unauthorized production, possibly of such low quality as to irreparably harm the businesses and/or consumer.

Luxury consumers are aspirational, and as they become familiar with authorized resellers of their goods, wish to be secure in the knowledge that they are purchasing the genuine item of the highest quality, for which they are paying a premium. The luxury manufacturer can convey this to the customer by specifically approving certain retailers as sources for their goods. The retailer completes the relationship by conveying that they have dealt with the manufacturer and consumer on solid ground.

The verification system of the present invention manages this relationship by holding an independent set of cryptographic relationships between the three entities involved. It is analogous to the “https” for luxury goods purchases. Every customer should know that their money is buying the best experience and product possible, and the verification system in accordance with embodiments of the present invention delivers that sense of security and satisfaction.

The cryptographic functions used may be drawn from a large pool of possibilities. For example, current best practice would encourage the use of the conventionally known SHA256 and HMAC algorithms, although various other cryptographic approaches may also or alternatively be employed. All standard libraries for various programming languages should make these available.

The system preferably provides APIs to make integration from the retailer and manufacturer sides simple and reliable, and provide examples and integration support for all major platforms and programming languages. The system may be vetted for security and integrity by additional third parties or the like, and may be “guaranteed” (i.e., users may be assured of the integrity of the system) to bring confidence to all parts of the relationship cycle.

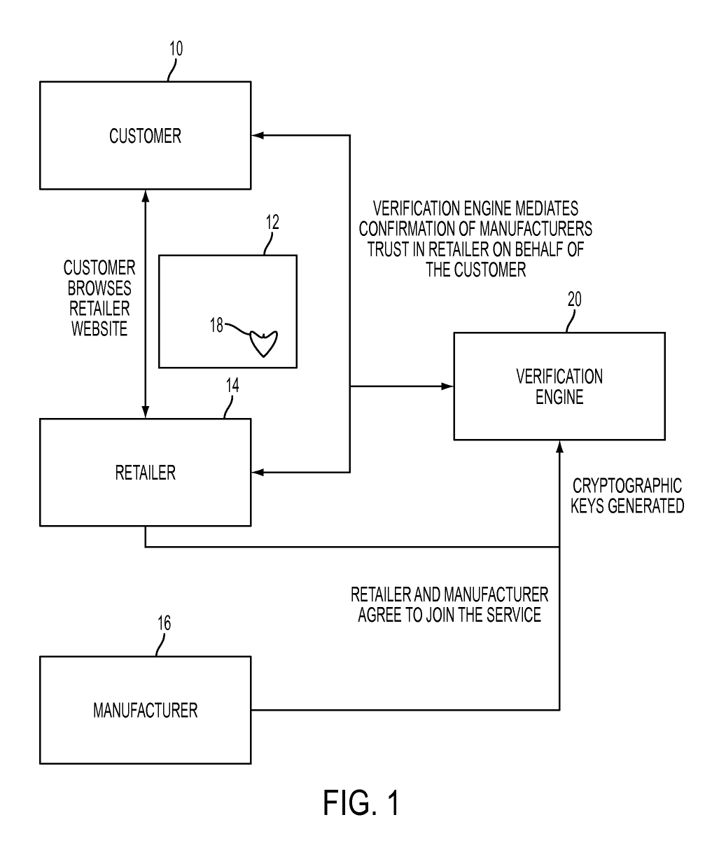

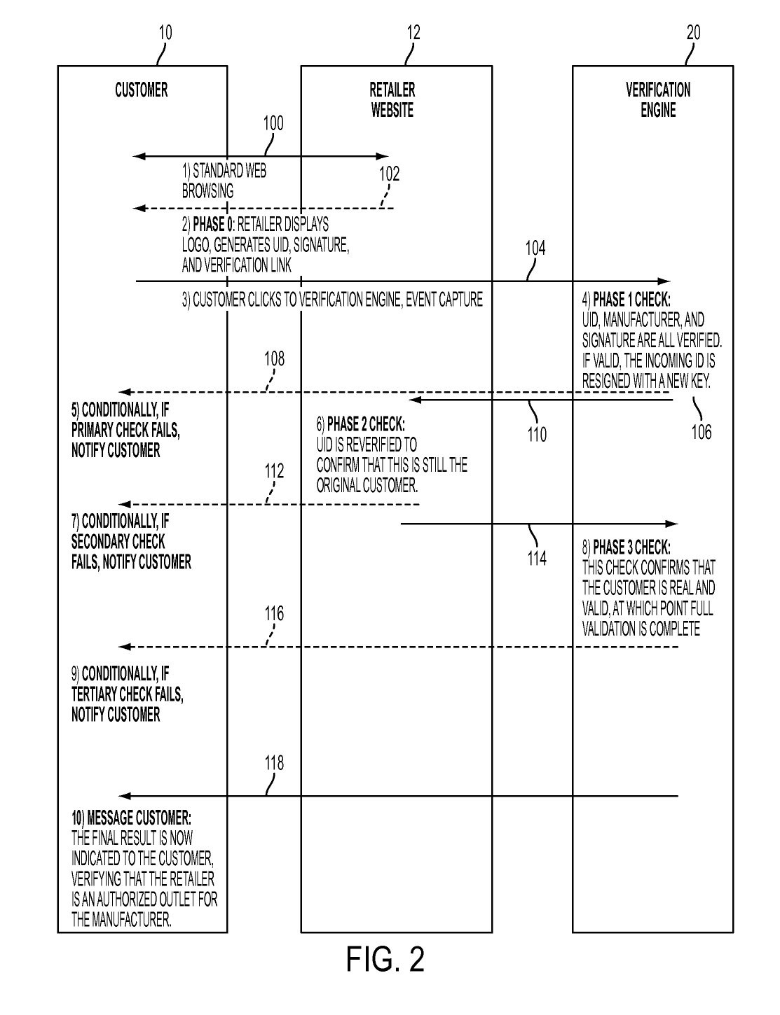

Although it may be employed very generally, the following exemplary embodiment described with respect to FIGS. 1 and 2 is within the context of an online retail model.

Initially, a retailer 14 and a manufacturer 16 of goods to be sold by the retailer 14 preferably enter into an agreement to join a service providing a trust verification system in accordance with the present invention. As a result of the agreement, one or more cryptographic keys and the like are generated and provided to a verification engine 20, which is preferably outside of the control of the retailer 14 and the manufacturer 16. The cryptographic keys are generated according to best practices established for the specific encryption methods employed. For example, HMAC encryption guidelines would require the generation of a string of 256 random bits, generally represented as a string of 32 alphanumeric characters, through a suitably strong random number generator, for example /dev/random employed by UNIX-like systems. The cryptographic keys will be communicated to the relevant counterparty in a secure manner, which may include the physical sending of a memory stick or card, by file exchange over the Internet, or by other conventional methods that protect the specific values of the keys.

The verification engine 20 is operated on one or more servers or like computing devices for performing the verification operations described in more detail below. Specifically, the verification engine 20 preferably includes a memory that may store the one or more cryptographic keys for use in the verification process, and which also may store instructions necessary for completing the verification operation. The verification engine 20 also preferably includes a controller (e.g., processor or the like) which is configured to operate based on the instructions to undertake the verification process. In one preferred embodiment, the verification engine is cloud-hosted. The benefits of cloud hosting include scalability and robustness to system downtime. However the system can be hosted in a colocation or other standard hosting facility, and the effectiveness of the system is largely independent of hosting aside from issues of scale and resiliency. The verification engine 20 is responsible for mediating confirmation of the trust of a manufacturer 16 in a particular retailer 14 on behalf of a customer 10.

The customer 10 may, in step 100 shown in FIG. 2, navigate a website 12 of a retailer 14 purporting to be a trusted sales channel for a goods manufacturer 16. The customer 10 preferably navigates the website 12 using a computer, tablet, mobile device, or other computing device. The website is preferably hosted on one or more servers or other computers (not shown) which may be in the possession of the retailer 14 or a third party hosting entity, and is preferably accessible over the Internet, although accessibility over a LAN, WAN, or the like is also possible in keeping with the invention. The website 12 may be written in conventional languages such as HTML, XML, or the like. The website 12 may, for example, indicate the retailer's 14 status as a trusted sales channel by presenting a verification logo 18 on at least the pages corresponding to the products associated with the manufacturer 16. The display of the verification logo 18 is performed as part of step 102 in FIG. 2, although this step may be performed separately. In addition, rather than using a logo 18, other methods of indicating verification, such as the use of text, pop-up windows, re-directed websites, or the like may be used.

At all stages of the exchange where a “signature” is verified, this represents the cryptographic analysis done by the system to confirm that the sender of the message is who it is believed to be. Only a sender in possession of the shared cryptographic key can generate the correct signature for a message. The HMAC protocol will be described and is referenced in the exemplary pseudocode appended below, but other techniques may be used. Fundamentally, data sent into the system is accompanied by a signature, which is generated by starting with the data and cryptographically operating against the shared cryptographic key. The receiving system can now take the data, cryptographically operate against the same shared cryptographic key, and compare the resulting signature to that sent by the sender. If the signatures match, the authenticity of the sent message is confirmed and the process can continue. If the signatures do not match, the identity of the sender is in question and the process should be halted.

As part of the integration into their systems, the retailer 14 preferably selects a customer-specific token UID against which cryptographic functions will be computed and a signature generated as part of step 102. Typically, the customer specific token UID may be the primary retailer session ID, but can be any customer-specific token, either already in use or created specifically for this purpose. To the customer-specific token UID, the retailer may further append a unix-format timestamp and the identification number of the manufacturer 16 of the product being verified. The retailer 14 then preferably constructs a link to a verification engine 20. The net statement being made is that the retailer 14 is an authorized sales channel for goods created by the manufacturer 16. An exemplary pseudo-code for implementing step 102 is attached as Appendix 1.

At step 104, the customer 10 may select or click the verification link, which in turn sends a request to the verification engine 20. The verification engine 20 is now tasked with validating the cryptographically signed information received by the link from the retailer. For example, at step 106, the verification engine 20 may verify the customer-specific token UID, the manufacturer 16 identification, and the signature. The verification system 20 further confirms that the signature of the data is valid for the retailer 14. An exemplary pseudo-code for implementing step 106 is attached as Appendix 2. Without knowing the specific key involved, this information cannot be produced in any other way, and would result in a “do not trust” response from the system to the consumer in step 108.

The verification engine 20 then preferably redirects to a service hosted by the retailer 14 at step 110. The service may be in the form of a simple API implemented in conventional e-commerce systems using conventional language likely to be in use on a modern e-commerce site. This service layer is responsible for validation of the incoming signed customer tokens sent by the verification engine 20, essentially checking that the verification request was not tampered with during data transmission, and that the tokens carried by this customer are those expected. The retailer 14 system would then generate a redirect back to the verification engine 20 for final confirmation. An exemplary pseudo-code for implementing step 110 is attached as Appendix 3. Any attempt to generate this connection without the shared key information would be unsuccessful, and result in a “do not trust” response from the system to the customer 10 in step 112.

Finally, having validated both the retailer 14 and the customer 10, and holding in trust the formal relationship between the retailer 14 and the manufacturer 16, the verification engine 20 validates the final incoming data from the previous step and displays its determination of the exchange—either that the retailer is to be trusted by the customer, as in step 114, or notifies the customer 10 in step 116 that the validation has failed. If the relationship is validated, the customer 10 may be notified by the verification engine 20 at step 118. An exemplary pseudo-code for implementing step 114 is attached as Appendix 4.

This exchange results in a strong signal to the customer 10 that the retailer 14 is carrying authentic product, and that their money will be well-spent. A fee may be assessed per verification (e.g., once per customer 10, per retailer 14, per manufacturer, and/or per day and the like) and/or a small portion of the final sale may be assessed.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein.

```
APPENDIX 1
PHASE 0, RETAILER SITE:
# our retailer id, assigned to us
var retid = 1;
# manufacturer of product we claim to legitimately sell
var manuid = 1;
# our customer sessionid or equivalent
var custid = customer.SESSION_ID;
# our phase 1 key, okay to hardcode this here
var ph1pw = ‘abcdefghijklm0123456789’;
# join data
var data = join(‘:’, retid, manuid, custid);
# generate signature
var sig = hmac(data, ph1pw, sha256);
# generate url
var link = “http://verificationengine/phase1?mark = data-sig”;
print (<html>We are a trusted retailer. <a href = “link”>Click here to confirm</a>.</html>);
APPENDIX 2
PHASE 1, VERIFICATION SITE:
# phase1, service to accept initial handshake, check, redirect to retailer phase2
# get incoming signature
var mark = getParam(‘mark’); e.g. 1:2:3:a1b2c3d4e5f6a1b2c3d4e5f6
# separate data and signature
var (data, sig) = split(‘-’, mark);
# split data into retailer, manufacturer, and customer id
var (retid, manuid, custid) = split(‘:’, data);
# initialize error variable
var error = ″;
# verify retailer and manufacturer relationship
var retmanu = checkRelationship(retid, manuid);
if (!retmanu) {
  error . = ‘According to the manufacturer, this retailer is not authorized to sell this product.’;
}
# retrieve retailers phase1 shared key from database
var ph1pw = getPhase1Key(retid); # e.g. abcdefghijklm0123456789
# generate signature from data and shared key
var checksig = hmac(data, ph1pw, sha256);
# compare generated signature to incoming signature, should match
if (checksig ! = sig) {
  error . = ‘This does not appear to be the retailer you think it is.’;
}
# if there was an error, tell the customer, otherwise proceed to phase2
if (error) {
  print “<html>”.msg.“</html>”;
}
else {
  # generate link to phase2, hosted by retailer
  # we need them to confirm the customer id, so sign that and redirect
  var ph2pw = getPhase2Key(retid); # e.g. 0123456789abcdefghijklm
  var url = getPhase2URL(retid);
  var unique = join(‘:’, retid, custid);
  # set local unique key for tracking
  setLocalRecord(unique); # should include timestamp
  var newsig = hmac(data, ph2pw, sha256);
  var param = data.‘-’.newsig;
  redirect(url.“?mark = ”.param);}
APPENDIX 3
PHASE 2, RETAILER SITE:
# service to accept secondary handshake, check, redirect to oursite phase2
# check incoming signature
var ph2pw = ‘0123456789abcdefghijklm’;
var mark = getParam(‘mark’);
var (retid, custid, sig) = split(‘-’, mark);
# initialize error variable
var error = ″;
# first check signature
var checksig = hmac(custid, ph2pw, sha256);
if (checksig ! = sig) {
  error . = ‘The site you were on was pretending to be us. Caveat Emptor.’;
}
# now check customer
var thiscustid = customer.SESSION_ID;
if (custid ! = thiscustid) {
  error . = ‘There was a problem with your customer id, please try again.’;
}
if (error) {
  print “<html>”.msg.“</html>”;
}
else {
  # generate the link to phase3, hosted by the trust service
  # this will convey that we have validated the customer
  var ph3pw = ‘9876543210nopqrstuvwxyz’;
  var timestamp = getCurrentUnixTime + 30; # 30 second window of validity
  var data = join(‘:’, retid, custid, timestamp);
  var sig = hmac(data, ph3pw, sha256);
  var link = “http://verificationengine/phase3?mark = data-sig”;
  redirect(link);
}
APPENDIX 4
PHASE 3, VERIFICATION SITE:
# phase3, accept tertiary handshake, check, display final trust determination
# get incoming signature
var mark = request->param(‘mark’);
# separate data and signature
var (data, sig) = split(‘-’, mark);
# split data into customer id and timestamp
var (retid, custid, timestamp) = split(‘:’, data);
# unique key for local tracking
var unique = join(‘:’, retid, custid);
# initialize error variable
var error = ″;
# retrieve retailers phase1 shared key from database
var ph3pw = getPhase3Key(retid); # e.g. abcdefghijklm0123456789
var checksig = hmac(data, ph3pw, sha256);
if (checksig ! = $sig) {
  error . = “This does not appear to be the retailer you think it is.’;
}
var nowtime = getCurrentUnixTime;
if ($nowtime > $timestamp) {
  error . = “The validation has expired, please try again.”;
}
if (isRecordExpired) {
  error . = “The validation has expired, please try again.”;
}
if (isRecordCompleted(unique)) {
  error . = “This check has already been performed.”;
}
var statement = ″;
if (error) {
  statement = ‘This is a trusted retailer.’;
}
else {
  statement = ‘This is not a trusted retailer.’;
}
# mark the record as completed
markRecordCompleted(unique);
print “<html>statement</html>”;)
```

What is claimed is:

1. A verification engine for verifying that a retailer is an authorized sales channel for goods created by a manufacturer, the verification engine comprising:
a memory configured to store a listing of authorized retailers for one or more manufacturers and a unique cryptographic key for each authorized retailer and manufacturer pair; and
a controller configured to:
(i) receive a request for verification from a purported retailer, the request being initiated by a computing device of a customer seeking to purchase goods made by one of the one or more manufacturers from the purported retailer, the request including verification data and a first signature, the verification data including at least an identification of the purported retailer and an identification of the goods manufacturer, and the first signature including a result of an operation on the verification data by a cryptographic key provided by the purported retailer,
(ii) compare the verification data to the listing in the memory to determine if the purported retailer is an authorized retailer of the goods manufacturer,
(iii) if the purported retailer is an authorized retailer of the goods manufacturer, operate on the verification data using the corresponding unique cryptographic key stored in the memory to generate a second signature;
(iv) compare the first and second signatures to one another, and
(v) send a message to the customer verifying or denying a relationship between the purported retailer and the goods manufacturer based on one or more of the comparison of the verification data with the listing and the comparison of the first and second signatures.

2. The verification engine of claim 1, wherein the request is generated from a web site of the purported retailer that is accessed by the computing device of the customer.

3. The verification engine of claim 2, wherein the web site includes a logo is selectable using the computing device of the customer to initiate the request.

4. The verification engine of claim 1, wherein the identification of the retailer is in the form of a customer-specific token UID.

5. The verification engine of claim 4, wherein the customer-specific token UID is a primary retailer session ID.

6. The verification engine of claim 1, wherein the unique cryptographic keys for the authorized retailer and manufacturer pairs are generated using HMAC protocol.

7. The verification engine of claim 1, wherein the verification data further includes a timestamp.
